(19) United States
(12) Patent Application Publication
(10) Pub. No.: US 2014/0261379 A1
(43) Pub. Date: Sep. 18, 2014

(54) COOKING GRILL

(71) Applicant: Tropitone Furniture Co., Inc., Irvine, CA (US)

(72) Inventors: Brian Adam Mehler, Long Beach, CA (US); Richard Rivera, Corona, CA (US)

(73) Assignee: Tropitone Furniture Co., Inc., Irvine, CA (US)

(21) Appl. No.: 14/205,201

(22) Filed: Mar. 11, 2014

Related U.S. Application Data
(60) Provisional application No. 61/878,540, filed on Sep. 16, 2013.
(60) Provisional application No. 61/799,011, filed on Mar. 15, 2013.

(51) Int. Cl. A47J 37/07

(52) U.S. Cl. CPC A47J 37/0763
USPC 126/25 R

(57) ABSTRACT

A fire pit or stovetop cooking grill can have a griddle and a cooking rack. The griddle can be used to cook food. The cooking rack can be on the griddle. The cooking rack can be used to cook food. The griddle can be on the fire pit or stovetop to provide a surface of heat for cooking food. The fire pit can provide a fire light ambiance while cooking with the cooking grill on the fire pit.

### CROSS-REFERENCE TO RELATED APPLICATIONS

This application claims the benefit under 35 U.S.C. §119(e) of U.S. Provisional Patent Application No. 61/799,011, titled “COOKING GRILL,” and filed on Mar. 15, 2013; and U.S. Provisional Patent Application No. 61/878,540, titled “COOKING GRILL,” and filed on Sep. 16, 2013. The above-identified patent applications are incorporated by reference in their entirety and made a part of this specification for all that they disclose.

### BACKGROUND

1. Field

This disclosure relates to cooking grills for preparing food and, more particularly, to cooking grills for preparing food over a fire pit.

2. Description of the Related Art

A number of cooking devices, such as barbeque grills, for cooking food are available. Cooking devices provide a heat source to cook the food. The cooking devices can provide the heat source using coals, firewood, natural gas, or electricity (e.g., heat plate, heat coils). Some cooking devices provide a grill over the heat source to cook the food. Some cooking devices provide a plate or pan over the heat source to cook the food. Some cooking devices integrate the grill or plate with the heat source, such as heat coils.

A number of fire pit devices are available. Fire pit devices can provide ambient light as well as limited heat for the enjoyment of an observer. Fire pit devices can provide the light and heat source using coals, firewood, natural gas, or electricity.

### SUMMARY

A need exists for cooking devices with a fire pit to provide a versatile fire pit cooking grill assembly for user enjoyment and/or cooking. A fire pit can provide ambient light and/or heat without cooking foods. The fire pit can have a cooking grill that can be removed when food cooking is not desired. A cooking grill can be used to cook food. While cooking food on the cooking grill, the fire pit can continue to provide ambient light and/or heat. The fire pit cooking grill assembly can provide an interactive and social cooking media on a fire pit that is relaxing and entertaining for the parties involved. A fire pit cooking grill can provide a central cooking area that is integral to a tabletop surface where each participant can cook food separately based on individual tastes. Small portions of meats, vegetables, and/or other food items can be provided to the participants who then add their selections to the central cooking area. Each participant seasons and cooks each item to their own tastes. When the food items are cooked, the participants remove them from the cooking area and place them directly on their plates for consumption.

The fire pit can have a tabletop. A user, which can include a group of users or a party of users, can use the tabletop as a table for setting items down, including food items, plates, utensil, etc. The user can also use it as a table for eating. Users can sit around the tabletop to cook on the cooking grill while still enjoying the luminescence and/or heat of a fire pit. Using a cooking grill with a fire pit can create a socially interactive cooking experience for the users. The tabletop and/or cooking grill can be a suitable height such that the user can see the food during cooking. The user can see the food while cooking on the cooking grill when standing up, sitting down, or both. A fire pit can serve as a patio or dining table. The cooking grill can be used with the fire pit or dining table. After cooking the food, the user can leave or remove the cooking grill from the fire pit or dining table while enjoying the cooked food at the same table. The user can manipulate controls on the fire pit that increase or decrease the ambient light and/or heat before, during, and after cooking.

The cooking grill can at least partially prevent the cooking juices of the food from falling on burning or hot non-disposable (or reusable) media of the fire pit. Burning or hot reusable media can include stones, glass, or other materials suitable that can withstand heat generated by the fire pit. The media can help with radiance of heat as well help provide ambience (luminescence). Cooking juices that buildup on the media may impair the media's ability to radiate heat and/or provide ambience. Further, preventing juices from falling on the media can help mitigate creating a mess during cooking and facilitate cleanup. Further, preventing juices from falling on the media can help prevent ruining the fire pit. For example, buildup of cooking juices on the burning or hot media may require changing out the burning or hot media. Cooking juices can also build up on the burners of the fire pit, which may require cleaning and/or changing of the burners. The cooking grill can be designed to avoid soot buildup on the cooking grill itself as discussed herein.

The cooking grill can have a cooking griddle. The griddle can be made of die cast or stamp-pressed aluminum, including aluminum alloys. Other suitable materials can include any suitable form or alloy of cast or wrought iron or carbon steel. The griddle can be used with metal cooking utensils without substantial damage or abrasion to the griddle. The griddle can have legs that rest around an opening of the fire pit containing the burner and burning or hot media. The griddle can have a middle portion (or cooking section) that slopes downwardly from a center of the griddle or slopes upwardly from a perimeter of the griddle to the center. The center of the cooking griddle can have a center opening.

A height of the legs, a slope and/or an arcuate shape of the middle portion, and a diameter of a center opening for the cooking grill can be arranged to achieve the following features. The arrangement can direct air, flame, heat, and/or combustion byproducts to help prevent flame rollout from sides of the cooking griddle during fuel combustion by the fire pit. The arrangement can direct air, flame, heat, and/or combustion byproducts to help prevent soot buildup on the griddle. The arrangement can direct air, flame, heat, and/or combustion byproducts to help create a vacuum that draws in air from the sides of the griddle for combustion by the fire pit. The arrangement can direct air, flame, heat, and/or combustion byproducts to help prevent melting of the griddle material. The arrangement can direct air, flame, heat, and/or combustion byproducts to help direct air, flame, heat, and/or combustion byproducts toward the center opening. The arrangement can make the middle portion of the griddle be the hottest portion of the cooking griddle during combustion of fuel by the fire pit. The heat can thermally conduct and dissipate throughout the griddle to create different heat zones on the griddle. The different heat zones can provide different cooking zones for a desired level of cooking based on a predetermined heat input.

The arrangement can create a partial vacuum at the sides of the cooking griddle to draw air in for improved combustion of the fuel by the fire pit. Proper combustion can include a desired flame color, height, and/or no or substantially no smoke. The created vacuum and/or proper combustion can also help prevent flame rollout from the sides of the griddle. Proper combustion can help prevent soot buildup on the griddle. Proper combustion can also help regulate flame color, size, and/or intensity (heat). The vacuum and/or proper combustion can at least in part be a result of the slope and/or the arcuate shape of the middle portion directing the air, flame, heat, and/or combustion byproducts toward the center of the griddle. The vacuum and/or proper combustion can at least in part be a result of the center opening through which air, flame, heat, and/or combustion byproducts can escape.

As part of the arrangement, the legs raise the cooking griddle above the opening and the burners of the fire pit. During combustion, heat is directed to the center opening of the griddle by the slope and/or the arcuate shape of the middle portion. The higher the legs raise the cooking griddle from the burners, the smaller the slope or the less arcuate the shape of the middle portion has to be in order to help prevent melting of the griddle and/or rollout of flames from the sides. As the air, heat, and/or combustion products are directed toward and out of the center opening, the flame is channeled toward the center opening to have a peak (highest) flame at the center opening due to an updraft or chimney effect. The updraft or chimney effect can help prevent the cooking griddle from melting and prevent flames from coming out of the sides of the griddle.

The griddle can have raised portions and/or recessed portions on the cooking surface. The raised portions and/or recessed portions can help elevate the food above the cooking surface of the griddle. The raised portions and/or recessed portions can help create barbeque sear marks in the food. The raised portions and/or recessed portions can help direct cooking juices toward a periphery or channel of the griddle. The slope and/or the arcuate shape of the middle portion can help direct cooking juices toward the periphery or channel of the cooking griddle.

The cooking grill can have a cooking rack. The cooking rack can rest on top of the cooking griddle. The cooking rack can elevate the food above the cooking griddle. The cooking rack can be wire frame structure. The wire frame structure can impart sear marks on the food during cooking and allow cooking juices to fall down onto the griddle below. The cooking grill can be substantially flat. The cooking grill can be sloped and/or follow the contour of the middle portion of the griddle. The cooking grill can have a cover plate arranged to be substantially over the center opening of the griddle. The cover plate can help prevent the cooking juices from dripping onto the burning or hot media through the center opening. The cooking grill can have different cooking zones as discussed herein for the griddle. The cooking zones can get relatively hotter toward the cover plate. The cooking grill can be removed from griddle to help prevent soot buildup on the food when cooking on the cover plate of the cooking rack, near the hottest cooking zone.

The cooking grill as discussed herein can be used on a stovetop, such as a commercial grade stovetop or fire pits, such as a propane and/or natural gas, wood, charcoal and/or electric fire pit. The stovetop or fire pit can have a heat output ranging from about 8,000 to about 100,000 BTUs. The foregoing heat output can make the cooking griddle reach temperatures of up to about 800° Fahrenheit. The heat source or flame of the fire pit can be under just a portion of the griddle. The heat can thermally conduct through the griddle, further contributing to the cooking zones discussed herein. The cooking grill can be particularly suitable for use on stovetops and fire pits that are hotter than typical or conventional stovetops or fire pits. Thus, the cooking grills versatility allows it be used over a broad range of cooking applications, including stovetops or fire pits designed to provide fire or light for ambiance that may have higher than typical BTU output.

The burner of the fire pit can be a 1 to 16 piece burner. The burner can also be a 6 piece burner. Numerical value of the pieces can represent individual burners of the fire pit that are operably connected. The pieces of the burners can have various shapes such as a star shape with a 5 piece burner or a hexagon with a 6 piece burner (or six arm star burner). The burners can have 3 to 100 combustion holes. In some embodiments, a smaller number of combustion holes in the burner piece directly correlates to relatively larger size of the combustion holes. A greater number of holes, such as 100 holes, in the burner allows for more air to be drawn in at the air intake of the fire pit, creating a more efficient burn. However, a more efficient burn can create less fire light ambiance (visible flame) that is desired from a fire pit flame. A large air intake for the fire pit can be provided to allow for a reduction of the number of combustion holes, such as 60 combustion holes in the burner, to have a more efficient burn of the flame while still providing fire light ambiance. The larger air intake can also create more intuitive control of the fire pit, such as the user turning up the gas to the fire pit to provide a larger flame and a hotter cooking surface without soot buildup. The larger air intake of the fire pit can help prevent soot buildup while cooking over a larger and hotter flame.

The fire pit can be designed to burn fuel at a high efficiency to minimize fuel consumption, as well as minimize the formation of byproducts (soot) that have not been fully consumed during the combustion process, which is undesirable and can be toxic to inhale. An inefficient flame can result in the formation of byproducts and black smoke. Byproducts can settle on the cooking grill as soot. An indication of efficient combustion can be the absence of smoke during combustion, a relatively low flame height, and a blue flame, indicating high temperatures, typically in excess of 1,000 degrees Fahrenheit. The fire pit designs disclosed herein can achieve a relatively high yellow luminescent flame while combusting fuel at a high temperature efficiently and cleanly. A high flame height can be about 2 to 8 inches and/or about 1 to 7 inches higher than a tabletop of the fire pit as discussed herein.

In accordance with embodiments disclosed herein, a cooking grill fire pit assembly is provided. The cooking grill fire pit assembly comprises a fire pit comprising a top supported by sides, the top including an opening bounded by a rim, the opening including a burner and heat conducting media supported in the opening. The cooking grill fire pit assembly further comprises a cooking element comprising legs configured to rest on the fire pit and a dome on the legs, the dome including a center opening elevated higher than the legs of the dome, a concave surface facing the opening of the fire pit, and a cooking surface facing away from the opening of the fire pit. The cooking grill fire pit assembly further comprises a cooking rack comprising a cover plate and configured to mate with the cooking element, the cooking rack configured to be positioned generally over the cooking surface of the cooking element such that the cover plate is vertically over the center opening of the cooking element. The legs are configured to elevate the cooking element above the burner to allow intake of air via a vacuum created when the burner combusts fuel. The concave surface facing the opening of the fire pit is configured to direct combustion byproducts and heat output toward the center opening of the cooking element when the burner combusts fuel. The center opening of the cooking element is configured to vent the combustion byproducts and the heat output when the burner combusts fuel. The cooking element and the cover plate are configured to generally cover the heat conducting media such that cooking juices from food cooking do not drip onto the heat conducting media.

In some embodiments, the opening of the fire pit is generally round and the cooking element is generally a same shape as the opening of the fire pit; the opening of the fire pit is generally square and the cooking element is generally a same shape as the opening of the fire pit; the cooking rack is generally round and the cooking element is configured to accept the round cooking rack; the cooking element is bound by a perimeter generally following the rim of the opening of the fire pit; the legs of the cooking element comprise a body with a protrusion; the body is configured to rest on the rim of the opening of the fire pit and the protrusion is configured to engage an inside of the opening at the rim such that the legs inhibit movement of the cooking element in at least a plane parallel to the rim of the opening; the legs elevate the cooking element above the burner to keep a material of the cooking element below a melting point of the material when the burner combusts fuel; the legs elevate the cooking element above the burner to inhibit flame out beyond a perimeter bounding the cooking element when the burner combusts fuel; a height of the legs, an arch of the concave surface facing the opening of the fire pit, and a diameter of the center opening of the cooking element are sized to prevent combustion byproduct buildup on at least one of the concave surface or the center opening of the cooking element; a height of the legs, an arch of the concave surface facing the opening of the fire pit, and a diameter of the center opening of the cooking element are sized to channel a flame when the burner combusts fuel toward the center opening of the cooking element such that a highest peak of the flame is at the center opening; a diameter of the opening of the fire pit is about 12 to about 18 inches; a height of the legs of the cooking element is about 0.5 to about 5 inches above the rim of the opening of the fire pit; a diameter of the center opening of the cooking element is about 1 to about 5 inches; the heat output of the fire pit when the burner combusts fuel is about 8,000 to about 100,000 British thermal units; a ratio of a total opening area of combustion holes of the burner to an opening area of a fuel orifice of the fire pit is about 1.5:1 to about 5:1; the ratio is configured to achieve about a 2 to 8 inch flame height with yellow luminescence generally without byproduct buildup on the concave surface of the cooking element facing the opening of the fire pit when the burner combusts fuel; the fuel orifice is configured to direct fuel to the burner; the burner comprises six arms; and/or the six arms each include 10 combustion holes.

In accordance with embodiments disclosed herein, a cooking grill assembly is provided. The cooking grill assembly comprises a cooking element comprising posts configured to rest on a fire pit and a circular pan on the posts leading toward a center opening, the circular top including a heat surface facing the fire pit and a cooking surface facing away from the fire pit. The cooking grill assembly comprises a cooking rack comprising a cover plate and configured to be on the cooking element, the cooking rack positioned generally over the cooking surface of the cooking element such that the cover plate covers the center opening of the cooking element. The posts are configured to elevate the cooking element above the fire pit to allow intake of air via a vacuum created during combustion of fuel by the fire pit. The heat surface facing the fire pit is configured to direct combustion byproducts and heat output of the fire pit toward the center opening of the cooking element during combustion of fuel by the fire pit. The center opening of the cooking element is configured to vent the combustion byproducts and the heat output of the fire pit during combustion of fuel by the fire pit.

In some embodiments, the cooking rack further comprises a circular wire frame bounding the cooking rack, the wire frame configured to mate with a circular groove of the cooking element such that the mating of the circular wire frame with the circular groove inhibits movement of the cooking rack in at least a plane parallel to the circular groove of the cooking element; and/or the heat and cooking surfaces are arcuate and a contour of the cooking grill generally follows the arcuate heat and cooking surfaces.

In accordance with embodiments disclosed herein, a cooking grill is provided. The cooking grill comprises a cooking element comprising posts configured to be on a fire pit and a frustum on the posts, the frustum including a center opening elevated above the legs, an inner surface facing the fire pit, and a cooking surface facing away from the fire pit. The posts are configured to elevate the cooking element above the fire pit to allow intake of air via a vacuum created during combustion of fuel by the fire pit. The inner surface facing the fire pit is configured to direct combustion byproducts and heat output of the fire pit toward the center opening of the cooking element during combustion of fuel by the fire pit. The center opening of the cooking element is configured to vent the combustion byproducts and the heat output of the fire pit during combustion of fuel by the fire pit.

In some embodiments, the frustum is generally circular and arcuate to form a dome such that the inner surface is generally arcuate; the frustum is generally circular and arcuate to form a dome such that the cooking surface is generally arcuate; an angle formed between a periphery of the cooking element and the center opening relative to a horizontal axis is about 0 to about 45 degrees; the cooking surface further includes raised portions configured to elevate food above the cooking surface; the raised portions are configured to direct cooking juices from food cooking toward a periphery of the cooking element; the cooking element further comprises a ridge bounding the cooking element, the ridge configured to contain cooking juices from food cooking within the cooking element; and/or the cooking element further comprises handles attached at a periphery of the cooking element, the handles configured to allow for positioning of the cooking element over the fire pit.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter discussed herein will become apparent in the teachings set forth herein. The summary is provided to introduce a selection of concepts in a simplified form that are further described below in the Detailed Description. This summary is not intended to identify key features or essential features of any subject matter discussed herein.

### BRIEF DESCRIPTION OF THE DRAWINGS

The foregoing and other features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

FIG. 1 illustrates a top perspective exploded view of an embodiment of a cooking grill 2.

FIG. 2 illustrates a top perspective view of an embodiment of the cooking grill.

FIG. 3 illustrates a top view of an embodiment of the cooking grill.

FIG. 4 illustrates a side view of an embodiment of the griddle.

FIG. 5 illustrates a bottom view of an embodiment of the griddle.

FIG. 6 illustrates a side view of an embodiment of the cooking rack.

FIG. 7 illustrates a bottom view of an embodiment of the cooking rack.

FIG. 8 illustrates a side view of an embodiment of the cooking grill.

FIG. 9 illustrates a top perspective exploded view of an embodiment of a cooking grill.

FIG. 10 illustrates a top perspective view of an embodiment of the cooking grill.

FIG. 11 illustrates a top view of an embodiment of the cooking grill.

FIG. 12 illustrates a side view of an embodiment of the griddle.

FIG. 13 illustrates a bottom view of an embodiment of the griddle.

FIG. 14 illustrates a side view of an embodiment of the cooking rack.

FIG. 15 illustrates a bottom view of an embodiment of the cooking rack.

FIG. 16 illustrates a side view of an embodiment of the cooking grill.

FIG. 17 illustrates a top perspective exploded view of an embodiment of a cooking grill.

FIG. 18 illustrates a top perspective view of an embodiment of the cooking grill.

FIG. 19 illustrates a top view of an embodiment of the cooking grill.

FIG. 20 illustrates a side view of an embodiment of the griddle.

FIG. 21 illustrates a bottom view of an embodiment of the griddle.

FIG. 22 illustrates a bottom view of an embodiment of the griddle.

FIG. 23 illustrates a side view of an embodiment of the cooking grill.

FIG. 24A illustrates a top perspective view of an embodiment of a fire pit.

FIG. 24B illustrates a top perspective view of an embodiment of a fire pit.

FIG. 25 illustrates a bottom perspective view of a burner tray.

FIGS. 26A-E illustrate an embodiment of a burner.

FIG. 27 illustrates a bottom perspective view of a fire pit.

FIG. 28A illustrates a top perspective view of an embodiment of a cooking grill on a fire pit.

FIG. 28B illustrates a top perspective view of an embodiment of the cooking grill on the fire pit zoomed in from FIG. 28A.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally discussed herein, and illustrated in the Figures, may be arranged, substituted, combined, and designed in a wide variety of different configurations, all of which are explicitly contemplated and made part of this disclosure.

FIG. 1 illustrates a top perspective exploded view of an embodiment of a cooking grill 2. The cooking grill 2 can have a cooking element or griddle 4 and a cooking rack 6. The griddle 4 can be generally round or circular as discussed herein. The griddle 4 can be other suitable shapes, such as square, rectangular, triangular, oval, or other polygonal and/or round shapes. The griddle 4 can have a cooking surface 8. In some embodiments, the cooking surface 8 can have raised portions 10. The raised portions 10 can help elevate at least a portion of food above the cooking surface 8. The raised portions 10 can impart sear marks on the food being cooked by the griddle 4. In some embodiments, the raised portions 10 can be circular from a top perspective, such as illustrated in FIG. 3, for each to generally have a same distance from a center axis or a circular perimeter or periphery rim 20 of the griddle 4. The raised portions 10 can have a decreasing diameter, moving from the circular perimeter to the center, such that the raised portions 10 are concentric and/or coaxial relative to each other around a vertical or central axis 15. In some embodiments, the griddle 4 can have 3 to 11 raised portions 10, including 5 to 9, and including 7 raised portions 10, including ranges bordering and the foregoing values.

The raised portions 10 can be semi-circular in profile and form a generally smooth transition from the cooking surface 8 to the raised portions 10. Smooth transitions can, for example, help with cleaning the griddle 4 after cooking food. In some embodiments, the raised portions 10 can have other profile shapes such as generally square, rectangular, triangular, oval, or other polygonal and/or round shapes. In some embodiments, the raised portions 10 can have can have corners based on the geometric shape of their profile. The raised portions 10 can have abrupt transitions between the cooking surface 8 and the raised portions 10.

The raised portions 10 can have breaks or cutouts. The breaks or cutouts can line up along a radius of the griddle 4 to form passages 12. The passages 12 can extend from the center of the griddle 4 to a channel 18 and/or periphery of the griddle 4. The passages 12 can direct cooking juices from the food being cooked toward the channel 18 and/or periphery of the griddle 4.

The griddle 4 can have an opening 14 in the center of the griddle 4. The opening 14 can have a diameter of about 1 to about 5 inches, including about 2 to about 4, and including about 3 inches, including ranges bordering and the foregoing values. The opening 14 can have an inner rim 16 that defines a periphery of the opening 14. The inner rim 16 can protrude upwards from the cooking surface 8. The inner rim 16 can help prevent cooking juices of the cooking food from running into the opening 14 when the food is on the cooking surface 8. The inner rim 16 can help prevent food from falling into the opening 14 when placed on the cooking surface 8.

The griddle 4 can have a channel 18 near the periphery of the griddle 4. The channel 18 can be a flat surface at the periphery of the griddle 4. In some embodiments, the channel 18 can be a u-shaped in profile. The channel 18 can have a smooth transition from the cooking surface 8 to the channel 18. The channel 18 can collect cooking juices that may flow down the cooking surface 8 and/or the passages 12.

The griddle 4 can have an edge or a periphery rim 20 at the periphery of the griddle 4. The periphery rim 20 can protrude upwards from the cooking surface 8 and/or the channel 18. The periphery rim 20 can help contain cooking juices within the griddle 4 and/or within the channel 18 during cooking. The periphery rim 20 can help prevent food from falling into the opening 14 when placed on the cooking surface 8.

The griddle 4 can have handles 22 attached to the griddle 4 at the periphery. In some embodiments, the handles 22 are attached to the periphery rim 20. The handles 22 can be attached to the griddle 4 and/or periphery rim 20 using any suitable mechanism, such as, for example, a screw, lock, solder, and/or adhesive mechanism. In some embodiments, the handles 22 are secured onto the griddle 4 and/or periphery rim 20 using nuts and bolts. In some embodiments, the handles 22 can be integrally formed with the griddle 4 and/or periphery rim 20. The handles 22 can help a user carry and position the cooking grill 2 in a predetermined position.

The griddle 4 can have legs 24. The legs 24 can be at or near the periphery of the griddle 4. In some embodiments, the legs 24 are positioned generally underneath the channel 18 as discussed herein. The channel 18 and/or periphery, such as the periphery rim 20, can extend beyond the connection area of the legs 24 to the griddle 4. The legs 24 can be integrally formed with the griddle 4. In some embodiments, the legs 24 can be connected to the griddle 4 using any suitable mechanism, such as, for example, a screw, lock, solder, and/or adhesive mechanism.

With continued reference to FIG. 1, the cooking rack 6 can be generally a same shape as the griddle 4, such as, for example, circular. Other suitable shapes for the cooking rack 6 can include square, rectangular, triangular, oval, or other polygonal and/or round shapes. The cooking rack 6 can rest or mate with the griddle 4 to form the cooking grill 2 as discussed herein. The cooking rack 6 can be made of die cast or stamp-pressed aluminum, including aluminum alloys. Other suitable materials can include any suitable form or alloy of cast or wrought iron or carbon steel, including stainless steel.

The cooking rack 6 can be formed from wires and/or rods joined together. The cooking rack 6 can have a periphery wire 26. The periphery wire 26 can be sized to rest or mate with the channel 18 at or near the periphery rim 20. In some embodiments, the periphery wire 26 can be sized to rest or mate with the channel 18 at or near where the channel 18 transitions from the cooking surface 8 to the channel 18, which can include an area near a raised portion 10.

Support wires 28 can be connected to the periphery wire 26 to form the framework for the cooking rack 6. In some embodiments, the support wire 28 can be connected to the periphery wire 26 using any suitable mechanism, such as, for example, a screw, lock, solder, and/or adhesive mechanism. In some embodiments, the support wires 28 can be integral with the periphery wire 26. The support wires 28 can extend generally upward from the periphery wire 26 and transition to proceed generally horizontal or inclined as discussed herein toward the center of the cooking grill 6.

Cooking wires 30 can be on the support wires 28 to form a cooking section 31. The cooking section 31 can generally correspond to the cooking surface 8 of the griddle 4. In some embodiments, the cooking wires 30 can be connected to the support wires 28 using any suitable mechanism, such as, for example, a screw, lock, and/or, solder, adhesive mechanism. In some embodiments, the cooking wires 30 can be integrally formed with the support wires 28. The cooking rack 6 can have 3 to 20 cooking wires 30, including 5 to 15 and 7 to 10 cooking wires 30, including ranges bordering and the foregoing values.

The cooking rack 6 can have a center plate 32. The center plate 32 can be on the support wires 28 and/or the cooking wires 30. In some embodiments, the center plate 32 can be connected to the support wires 28 and/or cooking wires 30 using any suitable mechanism, such as, for example, a screw, lock, and/or, solder, adhesive mechanism. In some embodiments, the center plate 32 can be integrally formed with the support wires 28 and/or cooking wires 30. The center plate 32 can be generally sized and/or positioned such that when the cooking rack 6 is on the griddle 4, the center plate 32 substantially covers the center opening 14 of the griddle 4 from a top perspective. Covering the opening 14 can help prevent cooking juices from falling onto burning or hot non-disposable (or reusable) media and/or burners of a fire pit exposed by the opening 14 as discussed herein. The burning or hot media can be any media that can be subjected to high temperatures of a fire pit, and in some implementations, conduct heat (e.g., heat conducting media)

FIG. 2 illustrates a top perspective view of an embodiment of the cooking grill 2. In some embodiments, the periphery wire 26 is sized to be substantially near the peripheral edge, such as the peripheral rim 20, of the griddle 4 in the channel 18 when the cooking rack 6 is on the griddle 4. In some embodiments, the periphery wire 26 is at or near a transition between the channel 18 and the cooking surface 8.

FIG. 3 illustrates a top view of an embodiment of the cooking grill 2. As discussed herein for some embodiments, the periphery wire 26 is at or near a transition between the channel 18 and the peripheral rim 20. The cover plate 32 of the cooking rack 6 can substantially cover the center opening 14 of the griddle 4. The cooking region 31 of the cooking rack 6 can substantially coincide with the cooking surface 8 of the griddle 4. In some embodiments, the cooking region 31 can extend over the channel 18.

FIG. 4 illustrates a side view of an embodiment of the griddle 4. In some embodiments, the cooking surface 8 is downwardly sloped from the center axis 15 at an angle θ₁ relative to a horizontal plane (perpendicular the center axis 15) or bottom of the griddle 4. In some embodiments, angle θ₁ is constant. In some embodiments, angle θ₁ varies throughout the cooking region 8 as discussed herein, and in particular, in reference to FIGS. 12 and 20. Angle θ₁ can vary from about 0 to about 45 degrees, including about 10 to about 35, and about 15 to about 25 degrees, including ranges bordering and the foregoing values.

With an angled cooking surface 8 and a flat top or peak of the griddle 4 as formed by the center opening 14, the shape of the griddle 4, and in particular the cooking surface 8 in combination with the center opening 14, can form a general shape of a frustum. A frustum can be defined as a cone with its top cut off. Other shapes can include a cone, dome, spherical, oval, and/or pyramidal shape.

The raised portions 10 can be concentric and/or coaxial as discussed herein along the cooking surface 8. In some embodiments, the raised portions 10 form a step pattern as illustrated in the side view of FIG. 4. The raised portions 10 can at least partially elevate the food relative to the cooking surface 8. The raised portions 10 can also aid in retaining the food in its initially placed position on the cooking surface 8.

The griddle 4 (e.g., a pan) can have legs 24. The legs 24 can have a body portion 34 and protrusion portion 36. The body portion 34 can be sized and positioned on the griddle 4 for the body portion 34 to rest on a rim of an opening of a fire pit as discussed herein, and in particular, in reference to FIG. 28A-B. The protrusion portion 36 can be integrally formed with the body portion 36. In some embodiments, the protrusion portion 36 can be attached to the body portion 34 using any suitable mechanism, such as, for example, a screw, lock, solder, and/or adhesive mechanism. The body portion 36 can be connected to the griddle 4 using any suitable mechanism discussed herein, and in particular, in reference to the connection between the griddle 4 and the legs 24. The protrusion portion 36 can be sized and positioned on the body portion 34 for the protrusion portion 36 to be on an inside portion of the opening of the fire pit as discussed herein, and in particular, in reference to FIGS. 28A-B.

FIG. 5 illustrates a bottom view of an embodiment of the griddle 4. In some embodiments, a protrusion port 36 can extend substantially along a length of a body portion 34 of the legs 24. The body portion 34 and/or protrusion portion 36 generally follow the contour of the overall griddle 4 shape and/or the rim of the fire pit as discussed herein, and in particular, in reference to FIGS. 28A-B.

The griddle 4 can have a convection surface 11 forming at least a part of a bottom of the griddle 4. The convection surface 11 can generally correspond in shape, contour, and/or slope to the cooking surface 8 of the griddle 4 as discussed herein. The convection surface 11 can form an internal side of the frustum of the griddle 4 as discussed herein. The convection surface 11 can be generally flat. The convection surface 11 can have an upward slope at an angle θ toward the center axis 15 as discussed herein for the cooking surface 8, and in particular, in reference to FIG. 4. The convection surface 11 can be arcuate and/or concave. The convection surface can have a curvature of an arcuate and/or circular shape with a radius R as discussed herein for the cooking surface 8, and in particular, in reference to FIGS. 12 and 20.

A peripheral bottom 13 can generally correspond to the channel 18 and/or peripheral rim 20 of the griddle 4. The peripheral bottom 13 can be substantially flat in a horizontal direction or substantially perpendicular to the center axis 15 as discussed herein. The peripheral bottom 13 can transition into the convection surface 11 generally at a region corresponding to a transition between the channel 18 and the cooking surface 8. In some embodiments, the legs 24 are connected to the griddle 4 at the peripheral bottom 13.

FIG. 6 illustrates a side view of an embodiment of the cooking rack 6. In some embodiments, the cooking section 31, and correspondingly the support wires 28 and/or the cooking wires 30, are downwardly sloped from the center axis 15 at an angle θ₂ relative to a horizontal plane (perpendicular the center axis 15). In some embodiments, angle θ₂ is constant. In some embodiments, angle θ₂ varies through the cooking region 8 as discussed herein, and in particular, in reference to FIGS. 12 and 20. Angle θ₂ can vary from about 0 to about 45 degrees, including about 10 to about 35, and about 15 to about 25 degrees, including ranges bordering and the foregoing values.

With an angled cooking section 31 and a flat top or peak of the cooking rack 6 as formed by the center plate 32, the shape of the cooking rack 6, and in particular the cooking section 31 in combination with the center plate 31, can form a general shape of a frustum as discussed herein. Other shapes can include a cone, dome, spherical, oval, and/or pyramidal shape.

The cooking wires 30 can be concentric and/or coaxial as discussed herein along the cooking section 31. In some embodiments, the cooking wires 30 form a step pattern as illustrated in the side view of FIG. 6. The cooking wires 30 can also aid in retaining the food in its initially placed position on the cooking section 31.

FIG. 7 illustrates a bottom view of an embodiment of the cooking rack 6. In some embodiments, the support wires 28 can lead from the periphery wire 26 to a center point of the cooking rack 6. The support wires 28 can terminate under the center plate 32. The support wires 28 can be connected to or formed integrally with the center plate 32 as discussed herein. The support wires 28 can be connected to or formed integrally with a support ring 38. The support ring 38 can be connected to the center plate 32 to form at least a partially rigid cooking rack 6.

FIG. 8 illustrates a side view of an embodiment of the cooking grill 2. The cooking rack 6 can be on the griddle 4 as discussed herein. The shape, contour, and/or slope of the cooking section 31 of the cooking rack 6 can generally follow the shape, contour, and/or slope of the cooking surface 8 of the griddle 4. The peripheral rim 20 can bound the periphery wire 26 to inhibit movement of the cooking rack 6 in at least the horizontal direction. The cooking grill 2 can include various other features and functions as discussed herein for some embodiments, and in particular, in reference to FIGS. 9-28B.

FIG. 9 illustrates a top perspective exploded view of an embodiment of a cooking grill 3. The embodiment of the cooking grill 3 illustrated in FIG. 9 can include generally similar features and functions of a cooking surface 8, peripheral bottom 13 (see FIG. 13), convection surface 11 (see FIG. 13), center opening 14, center axis 15, inner rim 16, channel 18, periphery rim 20, handles 22, legs 24, periphery wire 26, support wires 28, cooking wires 30, cooking section 31, and/or center plate 32 as discussed herein. The cooking grill 2 can include various other features and functions as discussed herein for other embodiments, and in particular, in reference to FIGS. 1-8 and 17-28B.

The griddle 5 can have grooves 40 that radiate from the center axis 15 to a periphery of the griddle 5. The grooves 40 can be raised relative to the cooking surface 8. The grooves 40 can elevate at least a portion of the food above the cooking surface 8. Raised grooves 40 can form scallops 42. The scallops 42 can direct cooking juices toward the periphery or the channel 18 of the griddle 5.

In some embodiments, the grooves 40 can be recessed or indented relative to the cooking surface 8. Recessed grooves 40 can form scallops 42. Recessed grooves 40 can direct cooking juices toward the periphery or the channel 18 of the griddle 5.

The cooking rack 7 can have fewer, but relatively thicker cooking wires 30 then some embodiments of the cooking rack 6 as discussed herein. The cooking wires 30 can impart sear marks on the food.

FIG. 10 illustrates a top perspective view of an embodiment of the cooking grill 3. The cooking rack 7 can be on and/or mate with the griddle 5 as discussed herein. The griddle 5 can inhibit at least horizontal movement of the cooking rack 7.

FIG. 11 illustrates a top view of an embodiment of the cooking grill 3. The center plate 32 of the cooking rack 7 can substantially cover the center opening 14 of the griddle 4. The cooking region 31 of the cooking rack 7 can substantially coincide with the cooking surface 8 of the griddle 5.

FIG. 12 illustrates a side view of an embodiment of the griddle 5. In some embodiments, the cooking surface 8 has a curvature of an arcuate and/or circular shape with a radius R. In some embodiments, the radius R varies throughout the cooking surface 8. For example, the radius R of the cooking surface 8 could be relatively smaller near the channel 18 or periphery of the griddle 5 and increase for the cooking surface 8 near to the center axis 15 or center opening 14. As another example, the radius R of the cooking surface 8 can be relatively larger near the periphery and/or center opening 14 and increase between the periphery and/or center of the griddle 5. As another example, the radius R of the cooking surface 8 can be relatively smaller near the periphery and/or center opening 14 and decrease between the periphery and/or center of the griddle 5. Radius R can vary between about 10 to about 100 inches, including about 15 to about 50 and about 20 to 25 inches, including ranges bordering and the foregoing values. The arcuate and/or circular cooking surface 8 can be sloped at an angle θ as discussed herein, and in particular, in reference to FIG. 4.

FIG. 13 illustrates a bottom view of an embodiment of the griddle 5. The griddle 5 can have a convection surface 11 forming at least a part of the bottom of the griddle 5. The convection surface 11 can generally correspond in shape, contour, and/or slope to the cooking surface 8 of the griddle 5. The convection surface 11 can form an internal side of the frustum of the griddle 5 as discussed herein. The convection surface 11 can be generally flat. The convection surface 11 can have an upward slope at an angle θ toward the center axis 15 as discussed herein for the cooking surface 8, and in particular, in reference to FIG. 4. The convection surface 11 can be arcuate and/or concave. The convection surface 11 can have a curvature of an arcuate and/or circular shape with a radius R as discussed herein for the cooking surface 8, and in particular, in reference to FIGS. 12 and 20.

FIG. 14 illustrates a side view of an embodiment of the cooking rack 7. The cooking rack 7 can have support wires 28 are substantially vertically rise from the periphery wire 26. The support wires 28 can radiate toward the center axis 15 generally horizontally or substantially perpendicular to the center axis 15. The cooking wires 30 can be on or be integral with the support wires 28 as discussed herein to form a generally horizontal cooking section 31.

FIG. 15 illustrates a bottom view of an embodiment of the cooking rack 7. In some embodiments, the support wires 28 can lead from the periphery wire 26 to a center point of the cooking rack 6. The support wires 28 can terminate under the center plate 32 at ends 44 away from the center of the cooking rack 7. The support wires 28 can be connected to or formed integrally with the center plate 32 as discussed herein to form at least a partially rigid cooking rack 7.

FIG. 16 illustrates a side view of an embodiment of the cooking grill 3. The cooking rack 7 can be on and/or mate with the griddle 5 as discussed herein. The cooking rack 7 can provide a generally horizontal cooking section 31. Various heat zones as discussed herein can correspond to various portions of the cooking section 31. For example, a hotter cooking zone can be toward the center of the cooking grill 3.

FIG. 17 illustrates a top perspective exploded view of an embodiment of a cooking grill 19. The embodiment of the cooking grill 19 illustrated in FIG. 17 can include generally similar features and functions of a cooking surface 8, peripheral bottom 17 (see FIGS. 21 and 22), convection surface 11 (see FIGS. 21 and 22), center opening 14, center axis 15, inner rim 16, channel 18, periphery rim 20, handles 22, legs 24, periphery wire 26, support wires 28, cooking wires 30, cooking section 31, center plate 32, grooves 40, and/or scallops 42 as discussed herein. The cooking grill 19 can include various other features and functions as discussed herein for some embodiments, and in particular, in reference to FIGS. 1-6 and 24-28B.

A griddle 9 of the cooking grill 19 can have a periphery rim 21 that is substantially square. The square periphery rim 21 can have, for example, rounded corners. The griddle 9 can be used with fire pits or other stoves having square openings for burners and burning or hot media. The griddle 9 can be used with fire pits or other stoves having circular openings for burners and burning or hot media. The griddle 9 can have a lip 46. The lip 46 can be substantially circular. The lip 46 can form a channel 47 between a cooking surface 8 and a landing surface 48. The landing surface 48 can be formed between the periphery rim 21 and the cooking surface 8 or the lip 46. The landing surface 48 can accommodate legs 24, 25 as discussed herein, and in particular, in reference to FIGS. 20-22.

FIG. 18 illustrates a top perspective view of an embodiment of the cooking grill 19. The cooking rack 7 can be on and/or mate with the griddle 9 as discussed herein. A periphery rim 26 can rest inside and/or mate with the lip 46. The lip 46 can inhibit movement of the cooking rack 7 in at least one direction. For example, the lip 46 can inhibit movement of the cooking rack 7 in a horizontal direction by bounding the periphery rim 26. The lip 46 can further provide an interference fit and/or snap fit mechanism to inhibit upward movement of the cooking rack 7 once the lip 46 bounds the peripheral wire 26.

FIG. 19 illustrates a top view of an embodiment of the cooking grill 19. The cooking region 31 of the cooking rack 7 can substantially coincide with the cooking surface 8 of the griddle 9. The lip 46 can be substantially adjacent to the periphery rim 21 at four points where the circular lip 46 coincides with the sides of the square periphery rim 21 when the lip 46 is sized to fit just within the periphery rim 21. In some embodiments, the landing area 48 extends completely around the lip 46, between the periphery rim 21 and the lip 46.

FIG. 20 illustrates a side view of an embodiment of the griddle 9. A cooking surface 8 of the griddle 9 can have a curvature of an arcuate and/or circular shape with a radius R as discussed herein. The cooking surface 8 can be sloped at an angle θ as discussed herein.

The griddle 9 can have legs 25. The legs 25 can be integrally formed with the griddle 9. In some embodiments, the legs 25 can be connected to the griddle 9 using any suitable mechanism, such as, for example, a screw, lock, solder, and/or adhesive mechanism. The legs 25 can have a body portion 35 and protrusion portion 37. The body portion 35 can be sized and positioned on the griddle 9 for the body portion 35 to rest on a square rim of an opening of a fire pit as discussed herein, such as analogously in reference to FIGS. 28A-B for a circular fire pit opening.

The protrusion portion 37 can be integrally formed with the body portion 35. In some embodiments, the protrusion portion 37 can be attached to the body portion 35 using any suitable mechanism, such as, for example, a screw, lock, solder, and/or adhesive mechanism. The body portion 35 can be connected to the griddle 9 using any suitable mechanism discussed herein, and in particular, in reference to the connection between the griddle 9 and the legs 25. The protrusion portion 37 can be sized and positioned on the body portion 35 for the protrusion portion 37 to be on an inside portion of the opening of the fire pit as discussed herein, and in particular, in reference to FIGS. 28A-B.

FIG. 21 illustrates a bottom view of an embodiment of the griddle 9. The griddle 9 can have a convection surface 11 as discussed herein, which can correspond in shape, contour, and/or slope to the cooking surface 8 of the griddle 4.

A peripheral bottom 17 of the griddle 9 can generally correspond to the landing surface 48, channel 18, and/or peripheral rim 21 of the griddle 4. The peripheral bottom 17 can be substantially flat in a horizontal direction or perpendicular to the center axis 15 as discussed herein. The peripheral bottom 17 can transition into the convection surface 11 generally at a region corresponding to a transition between the channel 18 and the cooking surface 8. The legs 24 can be connected to the griddle 9 at the peripheral bottom 17.

In some embodiments, a leg 25 has a protrusion portion 37 that projects from an inner corner of the body portion 35. The protrusion portion 37 can be relatively smaller than the body portion 35. The protrusion portion 37 can be generally square for the protrusion portion 37 to slide inside a corner of a square opening of a fire pit. Thus, the legs 35 can be positioned on the griddle 9 for the body portions 35 to rest on the rim at the corners and for the protruding portions 37 to slide against an inside of the corners of the square opening of the fire pit. The protrusion portions 37 can inhibit motion of the griddle 9 relative to the opening of the fire pit in at least one direction, such as, for example, the horizontal direction. In some embodiments, the protrusion portions 37 have an interference fit and/or snap fit mechanism with the rim of the fire pit to inhibit upward movement once the protrusion portions are engaged with the rim of the fire pit as discussed herein, and in particular, in reference to FIGS. 28A-B.

FIG. 22 illustrates a bottom view of an embodiment of the griddle 19. In some embodiments, the legs 24a-d can have a body portion 34 and protruding portion 36 as discussed herein, and in particular, in reference to FIGS. 4 and 5. The protruding portions 36 can extend along a length of the body portion 34. The protruding portions 36 can be substantially straight to generally follow the contour of the square periphery of the griddle 9 and/or a square opening of a fire pit. The protruding portions 36 can be rotated about 90 degrees relative to each other. The protruding portion 36 of leg 24a can be rotate 90 degrees relative to the protruding portion 36 of leg 24b. The protruding portion 36 of leg 24b can be rotate 90 degrees relative to the protruding portion 36 of leg 24c. The protruding portion 36 of leg 24c can be rotate 90 degrees relative to the protruding portion 36 of leg 24d. The protruding portion 36 of leg 24d can be rotate 90 degrees relative to the protruding portion 36 of leg 24a. When the griddle 9 rests on a square rim of an opening of a fire pit as discussed herein, such as analogously in reference to FIGS. 28A-B for a circular fire pit opening, the protruding portions 36 can be against an inside of the square rim at or near the corners to inhibit movement of the griddle 19 in at least one direction as discussed herein.

FIG. 23 illustrates a side view of an embodiment of the cooking grill 19. The cooking rack 7 can be on the griddle 9 as discussed herein. The cooking rack 7 can provide a generally horizontal cooking section 31. Various heat zones as discussed herein can correspond to various portions of the cooking section 31. For example, a hotter cooking zone can be toward the center of the cooking grill 19.

FIG. 24A illustrates a top perspective view of an embodiment of a fire pit 50. The fire pit 50 can have walls 52 between posts 53. The posts 53 can rest on the floor or ground below to provide support for the fire pit 50. The fire pit 50 can have double doors 54a, 54b. The doors 54a, 54b can swing open to reveal a space or compartment for storing the mechanisms for the fire pit 50 to function (i.e., combustion of fuel on the burners. The fire pit 50 can be a propane and/or natural gas fire pit. A propane tank can be housed within the walls 52 and doors 54a, 54b. In some embodiments, fire pit 50 can connect to and house a 1 lbs. propane tank for portability (i.e., for use during camping). In some embodiments, the fire pit 50 can connect to and house a 20 lbs. or any other size propane tank for longer fuel combustion time.

The fire pit 50 can have a tabletop 56. The tabletop 56 can be bound by a border 57. The tabletop 56 and border 57 can be circular. In some embodiments, the tabletop 56 and border 57 can be square. In some embodiments, the tabletop 56 and frame 57 can be any suitable shape, such as, for example, rectangular, triangular, oval, or other polygonal and/or round shapes.

The tabletop 56 can have an opening 58 (e.g., burner tray). The opening 58 can be generally round or circular as discussed herein. In some embodiments, the opening 58 can be square. In some embodiments, the opening 58 can be other suitable shapes, such as, for example, square, rectangular, triangular, oval, or other polygonal and/or round shapes. The opening 58 can be about 12 to about 18 inches in at least one dimension, including a diameter or a side.

FIG. 24B illustrates a top perspective view of another embodiment of a fire pit 50a. The fire pit 50a can have posts 53a similar to a conventional patio table. The posts 53a can rest on the floor or ground below to provide support for the fire pit 50a. The posts 53a can connect to supports 55 to help provide structural integrity to the fire pit 50a. The fire pit 50a can have a housing 59 for enclosing fuel combustion components as discussed herein, such as for example, a fuel connector 76, burner tray 58, and/or fuel, and supporting a user interface, such as for example, a controller 72. The housing 59 can have a door or other features to allow access to fuel combustion components. In some embodiments, the fire pit 50a can be assembled and disassembled quickly for portability (i.e., for use during camping). Assembly and disassembly can include engaging and disengaging the supports 55.

The fire pit 50a can have a tabletop 56. The tabletop 56 can be circular. In some embodiments, the tabletop 56 can be square. In some embodiments, the tabletop 56 can be any suitable shape, such as, for example, rectangular, triangular, oval, or other polygonal and/or round shapes. The fire pit 50a can have other features as described herein for the fire pit 50 with doors 54a, 54b.

The opening 58 can have a bottom 60. The opening 58 can be bounded by and/or connect to an inner wall 61. The inner wall 61 can be bounded by and/or connect to an inner rim 62. The inner rim 62 can protrude above the tabletop 56 level. In some embodiments, the inner rim 62 can be generally at the tabletop 56 level. The opening (or burner tray) 58 can contain burning or hot reusable media. The media can include stones, glass, or other materials suitable to withstand heat generated by the burners of the fire pit. In some embodiments, the opening or burner tray 58 can contain charcoal and/or wood to provide a source heat and/or light luminescence as discussed herein. In some embodiments, the burner tray 58 can house an electric heater to provide a source of heat and/or light luminescence as discussed herein.

In some embodiments, the burner tray 58 can house a pilot fire box 64. The pilot fire box 64 can be connected to the internal mechanisms of the fire pit such as, for example, a propane tank and an air intake. The pilot fire box 64 can be connected to burners 68. The burners 68 can be connected to the internal mechanisms of the fire pit such as, for example, the propane tank and the air intake.

In some embodiments, the fire pit 50 uses liquefied petroleum fuel. Liquefied petroleum can have many elements that are used during the manufacture of the fuel, which can result in fuel combustion with byproducts and soot buildup. The fire pit 50 can use air induction in the fuel stream to mitigate byproducts and soot buildup during combustion. Air induction can include forced air and/or drawn air through venturi induction. FIG. 25 illustrates a bottom perspective view of a burner tray 58 with a fuel connect 76. The fuel connect 76 can have a fuel orifice 78 with venturi openings (or air induction ports) 80. The venturi openings 80 can be located close to the point of combustion (i.e., relatively close to the burners 68) to aid in efficient fuel combustion and reduce undesirable pressure variances. Air and fuel can be induced by creating negative pressure at the fuel orifice 78. The BTU rating of the fire pit 50 can be based at least partly on the specific arrangement and vicinity of the fuel connecter 76, including fuel orifice 78 and fuel venturi openings 80. The fuel connect 76 can operably connect to a controller 72 of the fire pit 50 (see FIG. 27) to regulate combustion rate, flame height, and/or flame luminescence as discussed herein.

The burner 68 fire pit 50 can have 1 to 16 burner pieces (or arms), including 3 to 12 burner pieces, including 5 to 10 burner, including ranges bordering and the foregoing values, as discussed in further detail in reference to FIGS. 26A-E. The pieces of the burner can have various shapes such as, for example, a star shape with a 5 piece burner as illustrated in in FIG. 24A or a hexagon with a 6 piece burner (or 6 arm star burner). Different numbers of pieces and shapes of the burner can be used to provide various heat conduction, heat concentration, and/or burning rates. The burners 68 can have combustion openings or holes 70. The burners and/or arms can have 3 to 100 combustion holes, including 10 to 90, 20 to 80, 30 to 70, 40 to 60 combustion holes, including ranges bordering and the foregoing values. A greater number of holes, such as 100 holes, in the burner piece allows for more air to be drawn in at the air intake of the fire pit, creating a more efficient burn.

The number of combustion holes 70 can be optimized based at least partly on the size of the combustion holes 70. The pressure at the burner 68 should not exceed the pressure at the fuel orifice 78. If the pressure at the burner 68 is greater than the pressure at the fuel orifice 78, then back pressure may result in a reduction of air being inducted into the venturi openings 80. A reduction of air being inducted into the venturi openings 80 can result in unburned fuel. To avoid back pressure, the total area opening of the combustion holes 70 can equal or exceed the opening area of the fuel orifice. Increasing the number of combustion holes 70 can result in a more efficient burning fuel, but a lower flame height and less flame luminescence. For example, with an increased number of combustion holes 70, the back pressure at the fuel orifice 76 is decreased, resulting in a leaner fuel-air mixture. With a leaner fuel-air mixture, the resulting flame can be hotter and more efficient, but smaller and bluer (harder to see than a yellow flame). Reducing the number of combustion holes can result in a less efficient burn (the back pressure at the fuel orifice 76 is increased, resulting a richer fuel-air mixture), but a higher flame height and yellow flame luminescence. A balance between the number and the total area opening of the combustion holes 70 can be achieved to result in a high flame height with a high (yellow) flame luminescence and an efficient burn. A high flame height can be about 2 to 8 inches and/or about 1 to 7 inches higher than the tabletop of the fire pit.

The balance discussed above can result in a ratio range of the total orifice area of the combustion holes to the opening area of the fuel orifice 82. In some embodiments, the ratio of the areas can range from about 1.5:1 to 5:1, including 2:1 to 4.5:1, including ranges bordering and the foregoing values. For example, in one embodiment of the fire pit 50, sixty combustion holes 70 can each have an orifice opening area of about 0.094 inches, resulting in a total opening area of about 0.416 inches. In one embodiment, a 90,000 BTU fire pit can have an opening area of the fuel orifice 78 of about 0.107 inches. A total opening area of the combustion holes 70 of about 0.416 inches and an opening area of about 0.107 inches of the fuel orifice 78 results in a ratio of about 3.9:1. In some embodiments, the combustion holes 70 can each have an orifice opening area of about 0.05 to about 0.15 inches, including about 0.06 to 0.11 inches, including ranges bordering and the foregoing values. In some embodiments, the fuel orifice 78 can have an opening area of about 0.1 to about 1 inches, including about 0.2 to about 0.6 inches, including ranges bordering and the foregoing values. The burner and area ratio features discussed herein can be applied to liquefied petroleum, natural gas, and/or other similar fuels for the fire pit 50.

FIGS. 26A-E illustrate an embodiment of a 6 piece burner 68a. FIG. 26A is a top perspective view of the 6 piece burner 68a. The 6 piece burner 68a has six burner pieces (or arms) 82 that can radiate out from a center. The arms 82 can be pipe-like and hollow to carry fuel. The arms 82 can have end-caps 81 to cap the arms and help ensure that combustion does not occur at the side of the burner 68a (but through the combustion holes 70). As illustrated in FIG. 26E, the arms 82 can have an outer diameter D1 of about 0.3 to 1 inches, including about 0.4 to 0.8 inches, including ranges bordering and the foregoing values. The arms 82 can have an inner diameter D2 of about 0.1 to 0.8 inches, including 0.3 to 0.6 inches, including ranges bordering and the foregoing values. The diameters sizes can depend at least partly on BTU rating of the fire pit and a desired orifice opening area of the combustion holes 70. FIG. 26B illustrates a top view of the burner 68a. The burner 68a can form a generally circular shape with a diameter D3 to generally correspond with the shape of the opening 58. The diameter D3 can be about 10 to about 17 inches. In the embodiment illustrated in FIG. 26A-E, the burner 68a has thirty combustion holes 70 or five combustion holes 70 per arm 82.

FIG. 26C illustrates a side view of the 6 piece burner 68a. The burner 68a can have a connection manifold 84. The connection manifold 84 can mate with the fuel connector 76 with any suitable connection discussed herein. The burner 68a can have a height H from a bottom of the connection manifold 84 to a top of the burner 68a of about 0.5 to 4 inches, including 1 to 3 inches, including range bordering and the foregoing values. Depending on the height H, the burner 68a can have an arm slope angle θ3 of about 1 to 15 degrees, including about 2 to 10 degrees, including about 3 to 5 degrees, including ranges bordering and the foregoing values. The arm slope angle θ3 can help place the arms 82 closer to the cooking grill 2 to, for example, follow a sloped contour of the cooking grill 2 as discussed herein. Placing the arms 82 closer to the cooking grill 2 can help heat the cooking grill 2 to a higher temperature as discussed herein. Further, generally raising the elevation of the arms 82 relative to the burner tray 58 can help raise flame height for better flame luminescence.

FIG. 26D illustrates a bottom view of the 6 piece burner 68a. The burner 68a can have a connection manifold 84 with a pipe opening 86. The pipe opening 86 can mate with the fuel connector 76 as discussed herein. The pipe opening 86 can be any appropriate size to mate with fuel connector 76, including a ¼, ½, ¾, 1 inch, and more than 1 inch standard pipe coupling. Standard pipe coupling mechanisms can include threading, welding, interference fit, and/or the like.

FIG. 27 illustrates a bottom perspective view of a fire pit 50. The fire pit 50 can have the posts 53 supporting the tabletop 56. The doors 54a, 54b can have handles 74a, 75b for ease of opening.

The fire pit 50 can have a controller 72, such as, for example, a turning knob. The controller 72 can control the rate of fuel combustion by the burners 68. The controller 72 can control fuel intake. The controller 72 can control air intake. The controller 72 can be used to achieve a desired level of fire light ambiance from the flame and/or desired cooking temperature. The controller 72 can control a gas valve for regulating flame height. In some embodiments, the controller 72 can regulate the heat output and/or light luminescence for other types of heat and light sources of the fire pit 50, such as for example, an electric heater.

In some embodiments, the fire pit can have a heat output ranging from about 8,000 to about 100,000 BTUs, including about 20,000 to about 90,000 BTUs, including about 30,000 to about 80,000 BTUs, including ranges bordering and the foregoing values. The foregoing heat output can make the cooking griddle reach temperatures of up to about 800° Fahrenheit, up to about 700° Fahrenheit, including about 400 to 660° Fahrenheit, including ranges bordering and the foregoing values. The heat source or flame of the fire pit can be under just a portion of the griddle. The heat can thermally conduct through the griddle, further contributing to the cooking zones discussed herein. The cooking grill can be particularly suitable for use on stovetops and fire pits that are hotter than typical or conventional stovetops or fire pits. Thus, the cooking grills versatility allows it be used over a broad range of cooking applications, including stovetops or fire pits designed to provide fire or light for ambiance that may have higher than typical BTU output.

FIG. 28A illustrates a top perspective view of an embodiment of a cooking grill 2 on a fire pit 50. The cooking grill 2 can substantially cover an opening 58 of the fire pit 50. Legs 24 of the cooking grill 2 can be on an inner rim 62 and inner wall 61 (see FIG. 24A) to situate the cooking grill 2 over the opening 58.

FIG. 28B illustrates a top perspective view of an embodiment of the cooking grill 2 on the fire pit 50 zoomed in from FIG. 28A. When the cooking grill 2 is on top of the opening 58, a user can see inside the opening 58. For example, the user can see the burners 68. The user can see fire light ambiance from the fire pit 50 during combustion while simultaneously providing heat for cooking on the cooking grill 2. How much of the fire a user can see in the opening 58 is at least partially determined by a length of the legs 24 as discussed herein.

The legs 24 can have a body portion 34 and a protrusion portion 36 as discussed herein. The legs 24 can be positioned on the cooking grill 2 such that the body portion 34 of the legs rests on the inner rim 62 as discussed herein. The body portion 34 can elevate the bottom of the cooking grill 2 (or peripheral bottom 13, see FIG. 5) about 0.5 to about 5 inches, including about 1 to 3 inches, including ranges bordering and the foregoing values. The cooking grill 2 can be elevated above the inner rim 62 for the user to be able to still see the flame of the fire pit (i.e., fire light ambiance) while providing enough heat to the cooking grill 2 for cooking food.

The protrusion portion 36 can be correspondingly positioned on the body portion 34 for the protrusion portion 36 to be substantially against or mate with the inner rim 61 (see FIG. 28A) as discussed herein. In some embodiments, the protrusion portions 36 position the cooking grill 2 over the opening 58 in generally a predetermined position and inhibit horizontal movement. In some embodiments, the protrusion portions 36 connect or mate with the inner rim 61 to inhibit horizontal and/or vertical movement of the cooking grill 2 over the opening 58 as discussed herein. The body portion 34 and/or protrusion portion 36 generally follow the contour of the overall griddle 4 shape and/or the inner rim 62 and/or inner wall 61 of the fire pit 50 to nestle within the opening 58 at substantially a predetermined position.

The foregoing detailed description has set forth various embodiments of the systems and/or methods via the use of figures and/or examples. Insofar as such figures and/or examples contain one or more functions and/or operations, it will be understood by those within the art that each function and/or operation within figures or examples can be implemented individually and/or collectively. The herein described subject matter sometimes illustrates different components contained within, or connected with, different other components. It is to be understood that such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced embodiment recitation is intended, such an intent will be explicitly recited in the embodiment, and in the absence of such recitation no such intent is present. For example, as an aid to understanding, the following disclosure may contain usage of the introductory phrases “at least one” and “one or more” to introduce embodiment recitations. However, the use of such phrases should not be construed to imply that the introduction of an embodiment recitation by the indefinite articles “a” or “an” limits any particular embodiment containing such introduced embodiment recitation to embodiments containing only one such recitation, even when the same embodiment includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” or “one of the A, B, or C,” etc. is used, in general such a construction is intended in the sense one having skill in the art would understand the convention (e.g., “a system having at least one of A, B, and C (or one of the A, B, or C)” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, embodiments, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

1. A cooking grill fire pit assembly comprising:
a fire pit comprising a top supported by sides, the top including an opening bounded by a rim, the opening including a burner and heat conducting media supported in the opening;
a cooking element comprising legs configured to rest on the fire pit and a dome on the legs, the dome comprising a center opening elevated higher than the legs of the dome, a concave surface facing the opening of the fire pit, and a cooking surface facing away from the opening of the fire pit; and
a cooking rack comprising a cover plate and configured to mate with the cooking element, the cooking rack configured to be positioned generally over the cooking surface of the cooking element such that the cover plate is vertically over the center opening of the cooking element;
wherein the legs are configured to elevate the cooking element above the burner to allow intake of air via a vacuum created when the burner combusts fuel;
wherein the concave surface facing the opening of the fire pit is configured to direct combustion byproducts and heat output toward the center opening of the cooking element when the burner combusts fuel;
wherein the center opening of the cooking element is configured to vent the combustion byproducts and the heat output when the burner combusts fuel; and
wherein the cooking element and the cover plate are configured to generally cover the heat conducting media such that cooking juices from food cooking do not drip onto the heat conducting media.

2. (canceled)

3. The cooking grill fire pit assembly of claim 1, wherein the opening of the fire pit is generally square and the cooking element is generally a same shape as the opening of the fire pit.

4. (canceled)

5. The cooking grill fire pit assembly of claim 1, wherein the cooking element is bound by a perimeter generally following the rim of the opening of the fire pit.

6. The cooking grill fire pit assembly of claim 1, wherein each of the legs of the cooking element comprise a body with a protrusion, and wherein the body is configured to rest on the rim of the opening of the fire pit and the protrusion is configured to engage an inside of the opening at the rim such that the legs inhibit movement of the cooking element in at least a plane parallel to a periphery formed by the rim around the opening of the fire pit.

7. The cooking grill fire pit assembly of claim 1, wherein the legs elevate the cooking element above the burner to keep a material of the cooking element below a melting point of the material when the burner combusts fuel.

8. The cooking grill fire pit assembly of claim 1, wherein the legs elevate the cooking element above the burner to inhibit flame out beyond a perimeter bounding the cooking element when the burner combusts fuel.

9. The cooking grill fire pit assembly of claim 1, wherein a height of the legs, an arch of the concave facing the opening of the fire pit, and a diameter of the center opening of the cooking element are sized to prevent combustion byproduct buildup at least one of on the concave surface or around the center opening of the cooking element.

10. The cooking grill fire pit assembly of claim 1, wherein a height of the legs, an arch of the concave surface facing the opening of the fire pit, and a diameter of the center opening of the cooking element are sized to channel a flame when the burner combusts fuel toward the center opening of the cooking element such that a highest peak of the flame is at the center opening.

11. (canceled)

12. The cooking grill fire pit assembly of claim 1, wherein a height of the legs of the cooking element is about 0.5 to about 5 inches above the rim of the opening of the fire pit.

13. The cooking grill fire pit assembly of claim 1, wherein a diameter of the center opening of the cooking element is about 1 to about 5 inches.

14. The cooking grill fire pit assembly of claim 1, wherein the heat output of the fire pit when the burner combusts fuel is about 8,000 to about 100,000 British thermal units.

15. The cooking grill fire pit assembly of claim 1, wherein a ratio of a total opening area of combustion holes of the burner to an opening area of a fuel orifice of the fire pit is about 1.5:1 to about 5:1, wherein the ratio is configured to achieve about a 2 to 8 inch flame height with yellow luminescence generally without byproduct buildup on the concave surface of the cooking element facing the opening of the fire pit when the burner combusts fuel, and wherein the fuel orifice is configured to direct fuel to the burner.

16. The cooking grill fire pit assembly of claim 15, wherein the burner comprises six arms, and wherein the six arms each include 10 combustion holes.

17. A cooking grill assembly comprising:
a cooking element comprising posts configured to rest on a fire pit and a circular pan on the posts leading toward a center opening, the circular pan comprising a heat surface facing the fire pit and a cooking surface facing away from the fire pit; and
a cooking rack comprising a cover plate and configured to be on the cooking element, the cooking rack positioned generally over the cooking surface of the cooking element such that the cover plate covers the center opening of the cooking element;
wherein the posts are configured to elevate the cooking element above the fire pit to allow intake of air via a vacuum created during combustion of fuel by the fire pit;
wherein the heat surface facing the fire pit is configured to direct combustion byproducts and heat output of the fire pit toward the center opening of the cooking element during combustion of fuel by the fire pit; and
wherein the center opening of the cooking element is configured to vent the combustion byproducts and the heat output of the fire pit during combustion of fuel by the fire pit.

18. The cooking grill assembly of claim 17, wherein the cooking rack further comprises a circular wire frame bounding the cooking rack, the wire frame configured to mate with a circular groove of the cooking element such that the mating of the circular wire frame with the circular groove inhibits movement of the cooking rack in at least a plane parallel to a periphery formed by the circular groove of the cooking element.

19. The cooking grill assembly of claim 17, wherein the heat and cooking surfaces are arcuate and a contour of the cooking element generally follows the arcuate heat and cooking surfaces.

20. A cooking grill comprising:
a cooking element comprising posts configured to be on a fire pit and a frustum on the posts, the frustum comprising a center opening elevated above the posts, an inner surface facing the fire pit, and a cooking surface facing away from the fire pit; and
wherein the posts are configured to elevate the cooking element above the fire pit to allow intake of air via a vacuum created during combustion of fuel by the fire pit;
wherein the inner surface facing the fire pit is configured to direct combustion byproducts and heat output of the fire pit toward the center opening of the cooking element during combustion of fuel by the fire pit; and
wherein the center opening of the cooking element is configured to vent the combustion byproducts and the heat output of the fire pit during combustion of fuel by the fire pit.

21. (canceled)

22. (canceled)

23. The cooking grill of claim 20, wherein an angle formed between a periphery of the cooking element and the center opening relative to a horizontal axis is about 0 to about 45 degrees.

24. The cooking grill of claim 20, wherein the cooking surface further includes raised portions configured to elevate food above the cooking surface.

25. The cooking grill of claim 24, wherein the raised portions are configured to direct cooking juices from food cooking on the cooking grill toward a periphery of the cooking element.

26. The cooking grill of claim 20, wherein the cooking element further comprises a ridge bounding the cooking element, the ridge configured to contain cooking juices from food cooking on the cooking grill within the cooking element.

27. (canceled)

28. The cooking grill fire pit assembly of claim 1, wherein the fire pit comprises a table, and the sides comprise posts of the table, the posts configured to support the table on a resting surface, and wherein the table further comprises a housing on a bottom side of the top, the bottom side facing the resting surface, the housing enclosing the opening of the fire pit.

29. The cooking grill fire pit assembly of claim 5, wherein the cooking rack is generally round and the cooking element is configured to accept the round cooking rack within the perimeter of the cooking element.

30. The cooking grill assembly of claim 17, wherein the fire pit comprises a table comprising legs configured to support the table on a resting surface.

31. The cooking grill of claim 20, wherein the frustum is generally circular and arcuate to form a dome such that the inner surface and the cooking surface are generally arcuate.

32. The cooking grill of claim 20, wherein the fire pit comprises a table comprising legs configured to support the table on a resting surface.
